(19) United States
(12) Patent Application Publication
(10) Pub. No.: US 2008/0082428 A1
(43) Pub. Date: Apr. 3, 2008

(54) Systems and methods for automatically resolving stock discrepancies

(76) Inventors: Andrew C. Stein, Morton, IL (US); Tammi L. Duncan, Pekin, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/529,476

(22) Filed: Sep. 29, 2006

(51) Int. Cl. G06Q 10/00

(52) U.S. Cl. 705/28

(57) ABSTRACT

Systems and methods are provided for automatically resolving stock discrepancies. In one embodiment, a difference analyzer stores a record of a claim specifying a discrepancy involving stock. An inventory server comprises a database of inventory records. The inventory server determines an aggregate quantity of all stock having a product number corresponding to the claim and having any country of origin, stock type, or document category. The inventory server further determines whether the discrepancy falls within a tolerance.

### TECHNICAL FIELD

The present disclosure relates generally to automatically resolving stock discrepancies, and more particularly, to systems and methods for automatically determining whether to update bin quantities for a particular stock in an inventory system.

### BACKGROUND

In a warehouse, storage areas for storing stock may include rows of shelves that include a large number of storage bins. The storage bins are typically labeled so that workers can locate stock in the warehouse. During warehouse operations, workers may need to locate stock for a variety of reasons. For example, workers may need to locate stock in order to ship the stock outside of the warehouse to satisfy an order placed by a customer for a certain quantity of a particular stock. Workers may also need to ship stock outside of the warehouse due to an inter-facility order (i.e., a transfer of the stock from one warehouse to another). Alternatively, workers may need to ship stock intra-facility to reorganize stock in the warehouse (i.e., moving stock from one bin to another in the same warehouse).

When stock is shipped outside of the warehouse or moved to a new location, a worker typically updates a computerized inventory system in order to record an updated bin quantity of the stock. Such a system may maintain location information describing where stock is located in the warehouse. For example, the worker may use a scanner to scan a bar code or radio frequency identification (RFID) tag on a bin to record movement of the stock from the bin. A database in the computerized inventory system is then updated to reflect a new quantity for the bin.

Discrepancies between actual inventory levels (i.e., the amount of stock physically located in a particular bin) and bin quantities in the computerized inventory system may occur for a variety of reasons. For example, a customer, such as a dealer ordering stock from a distributor, may submit a claim to the distributor indicating that a certain quantity of the stock was missing from a shipment (i.e., the customer ordered five of a particular item but received four). If the customer did not receive some of the stock, one might expect to find the missing stock in a bin in the warehouse. In other situations, a claim may be submitted by another warehouse (i.e., an inter-facility claim) indicating that stock was missing from the shipment or an intra-facility claim may occur when a discrepancy occurs when stock is moved within a warehouse. In these kinds of situations, in order to resolve the discrepancy, a worker typically manually counts the number of items in a particular bin. However, sending a worker to count the bin is often time consuming and an inefficient use of resources when a worker recounts a bin storing stock having a low cost. Furthermore, the process is often complicated by the practice of storing quantities of stock in multiple locations and/or bins based on the country from which the stock originated.

One method of managing inventory is described in U.S. Publication No. 2003/0120563 A1 (the '563 application) to Meyer, which published on Jun. 26, 2003. The '563 application describes a method to identify discrepancies in current inventory records and establishes a plan to correct the discrepancies. Although the system of the '563 application may take into account a cost of a part to resolve a discrepancy, the method nevertheless has several disadvantages. For example, the method of the '563 application does not taken into account an aggregate total for all items of a particular kind of stock that are located in a warehouse. In particular, the method of the '563 application does not resolve discrepancies by aggregating quantities of a particular stock even if stock items are stored in separate bin locations due to differing countries of origin.

The disclosed system and methods are directed to overcoming one or more of the problems set forth above.

### SUMMARY OF THE INVENTION

In one aspect, the present disclosure is directed to a system for automatically resolving stock discrepancies. The system may comprise a difference analyzer that stores a record of a claim specifying a discrepancy involving stock. The system may also comprise an inventory server. The inventory server may comprise a database of inventory records. The inventory server may determine an aggregate quantity of all stock having a product number corresponding to the claim and having any country of origin, stock type, or document category. The inventory server may further determine whether the discrepancy falls within a-tolerance.

In another aspect, the present disclosure is directed to a method for automatically resolving stock discrepancies. The method may include receiving a claim specifying a discrepancy involving stock. A record of the claim may be stored in a difference analyzer. The method may determine an aggregate quantity of all stock that is stored in a database of an inventory server that has a product number corresponding to the claim and has any country of origin, stock type, or document category. The method may further determine whether the discrepancy falls within a tolerance.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments. In the drawings:

FIG. 1 is an exemplary warehouse environment, consistent with a disclosed embodiment;

FIG. 2 is an exemplary system for automatically resolving stock discrepancies, consistent with a disclosed embodiment;

FIG. 3 is an exemplary data table of exemplary inventory records, consistent with a disclosed embodiment;

FIG. 4 is an exemplary data table of exemplary records for storing stock discrepancies, consistent with a disclosed embodiment;

FIG. 5 is an exemplary software architecture for evaluating stock discrepancies and automatically determining whether to update bin quantities for a particular stock in an inventory server, consistent with a disclosed embodiment; and

FIG. 6 is a flow diagram of an exemplary method for evaluating stock discrepancies and automatically determining whether to update bin quantities for a particular stock in an inventory system, consistent with a disclosed embodiment.

### DETAILED DESCRIPTION

Reference will now be made in detail to exemplary embodiments, which are illustrated in the accompanying drawings. Wherever possible, the same reference numbers will be used throughout the drawings to refer to the same or like parts.

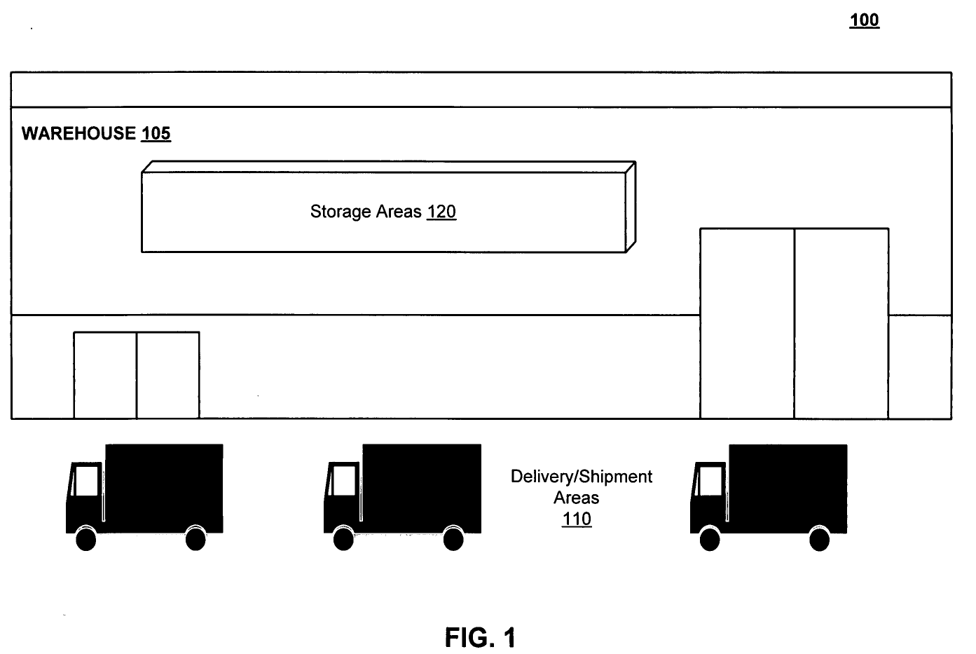

FIG. 1 is an exemplary warehouse environment 100, consistent with a disclosed embodiment. Warehouse environment 100 includes warehouse 105, which handles and stores stock. In one embodiment, warehouse 105 may function as the main warehouse facility of a supplier or merchant of goods or services. In other embodiments, warehouse 105 may be one of several warehouse facilities that are regionally located and/or part of a distribution network.

As used herein, the term “stock” refers to any quantity of an item in a warehouse or other facility. For example, stock may comprise any quantity or number of parts for manufacturing or providing a finished product, or any quantity or number of parts that are used for providing services. Stock may also comprise commercial products or any other item. By way of further example, in the context of a warehouse environment for a machinery supplier, stock may comprise machinery parts, engine parts, heavy equipment parts and the like.

Warehouse 105 may include a number of areas. For example, warehouse 105 may include one or more delivery and/or shipment areas 10 for receiving and shipping stock. Delivery/shipment areas 110 may include dock areas where shipping vehicles (e.g., shipping trucks, vans, etc.) are received. These dock areas may be used for the unloading or loading of pallets of stock. In addition, one or more storage areas 120 may store stock inside of warehouse 105. Storage areas 120 may include a large number of storage bins that are arranged, for example, in rows of shelves (not shown). Additionally, or alternatively, other types of storage elements (such as containers, buckets, barrels and the like) may be used in storage areas 120.

Conventional techniques may be used for organizing and storing stock in storage areas 120. For example, bins located in storage areas 120 may be labeled for ease of identification. Labeling may be achieved through the use of any type of indicia or label, such as bar code labels or RFIDs. In addition to labeling the bins, each storage area (e.g., each row of shelf space, etc.) in storage areas 120 may be labeled or otherwise marked. Using the relevant row and bin information, warehouse workers may locate stock in the warehouse.

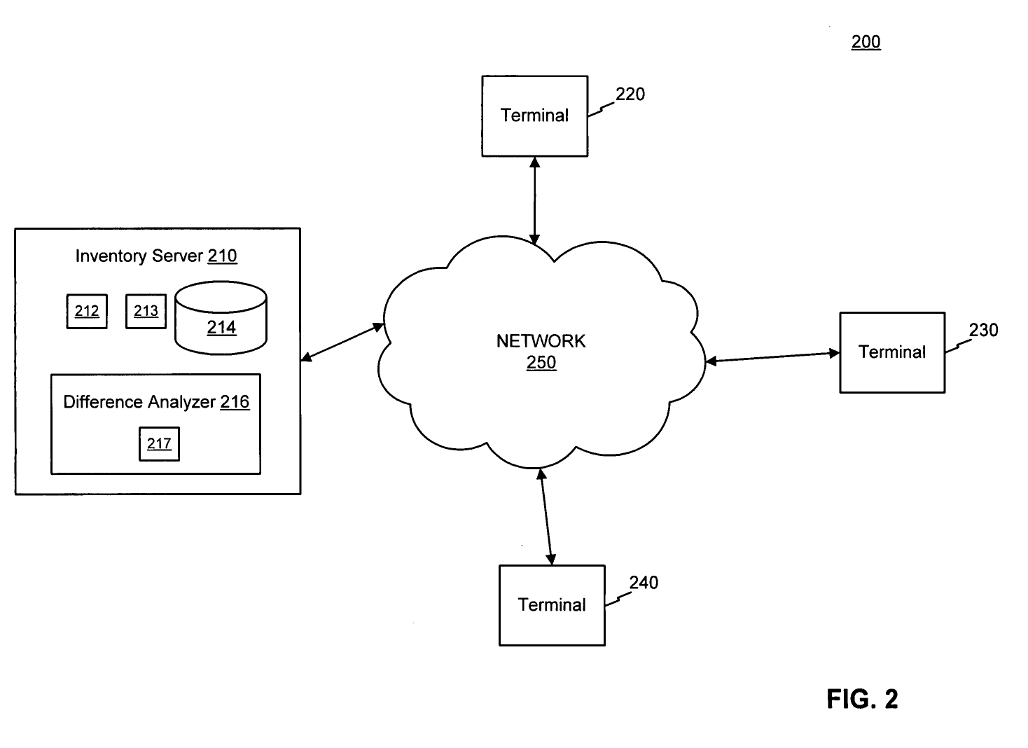

To control the movement of stock in warehouse 105, warehouse workers may use a computerized inventory system (not shown in FIG. 1). Such a system may maintain location information (e.g., row and bin information) for all stock in the warehouse. The system may also maintain and issue orders to instruct warehouse workers to move stock in the warehouse and to pack stock for shipment outside of the warehouse. To accomplish the above and other functionality, the system may include software-enabled logic and a database, as is described in further detail with regard to FIG. 2.

FIG. 2 is an exemplary system 200 for automatically resolving stock discrepancies, consistent with a disclosed embodiment. As shown in system 200, inventory server 210, and terminals 220, 230, and 240 are connected to a network 250. One of skill in the art will appreciate that although three terminals are depicted in FIG. 2, any number of terminals may be provided. Further, one of ordinary skill in the art will recognize that functions provided by one or more components of system 200 may be combined.

Network 250 provides communications between the various entities in system 200, such as inventory server 210 and terminals 220-240. In addition, inventory server 210 and terminals 220-240 may access legacy systems (not shown) via network 250, or may directly access legacy systems and/or databases. Network 250 may be a shared, public, or private network, may encompass a wide area or local area, and may be implemented through any suitable combination of wired and/or wireless communication networks. Furthermore, network 250 may comprise a local area network (LAN), a wide area network (WAN), an intranet, or the Internet.

Inventory server 210 may comprise a general purpose computer (e.g., a personal computer, network computer, server, or mainframe computer) having a processor 212 that may be selectively activated or reconfigured by a computer program and data storage 213 for storing program instructions. Inventory server 210 may also be implemented in a distributed network. Alternatively, inventory server 210 may be specially constructed for carrying-out methods consistent with a particular embodiment. Accordingly, inventory server 210 may include software-based logic (not shown) for tracking the day-to-day movement of stock in and out the warehouse.

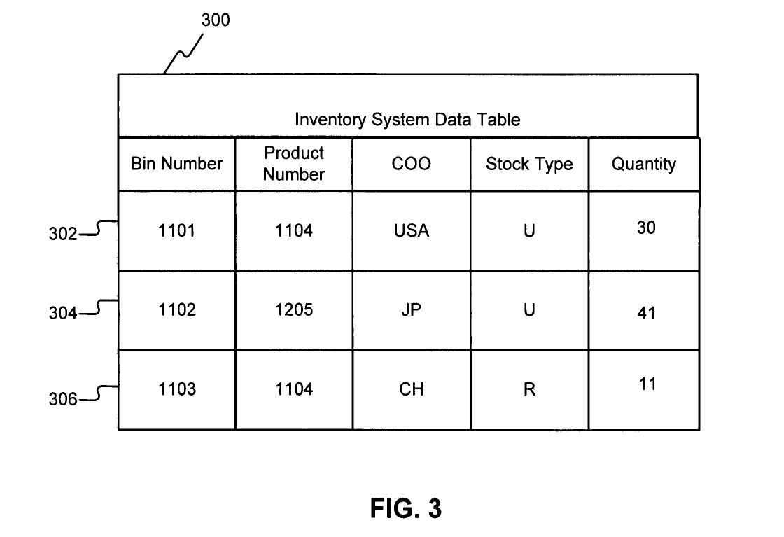

Furthermore, inventory server 210 may include a processor 212 and a database 214 for storing data records for stock in warehouse 105. For example, data records stored in database 214 may each specify a bin number, product number, country of origin (COO), stock type, and quantity of the stock in a bin. Bin numbers and product numbers may include numerical digits, letters, or a combination of alphanumeric characters. The “stock type” may indicate whether the stock is or is not currently available for sale. For example, the “stock type” may be unrestricted (i.e., the stock is currently available for sale) or restricted (i.e., the stock is not currently for sale). An exemplary data structure including exemplary records that may be stored in database 214 of inventory server 210 is described in more detail in connection with FIG. 3.

In one embodiment, in order to update database 214 of inventory server 210, an inventory count document is created for a particular stock and all bins are counted for that stock. Then, updated quantities of each bin are entered in inventory server 210. Updates may be processed by workers at terminals 220-240 and/or by using handheld devices (not shown), such as scanners, to scan a bar code or radio frequency identification (RFID) tag on the bin to record the movement of the stock from the bin and/or to indicate a quantity of stock counted for a particular bin.

Furthermore, inventory server 210 may provide functionality for evaluating stock discrepancies and automatically determining whether to update bin quantities for a particular stock in database 214. For example, software modules stored in data storage 213 may generate program instructions to evaluate a discrepancy and automatically determine whether to update bin quantities in inventory server 210.

Inventory server 210 may also include difference analyzer 216. Difference analyzer 216 may include a data storage 217. Data storage 217 may store discrepancy data. Furthermore, in some embodiments, data storage 217 may store program instructions for evaluated a discrepancy and automatically determine whether to update bin quantities in inventory server 210.

As shown in FIG. 2, difference analyzer 216 is included in inventory server 210. However, one of ordinary skill in the art will recognize that the components and functionality of difference analyzer 216 may be provided by a separate component in system 200. For example, difference analyzer 216 may be implemented as a computing-based platform (e.g., a workstation, a computer, a laptop, a server, a network computer and the like) that is available via network 250.

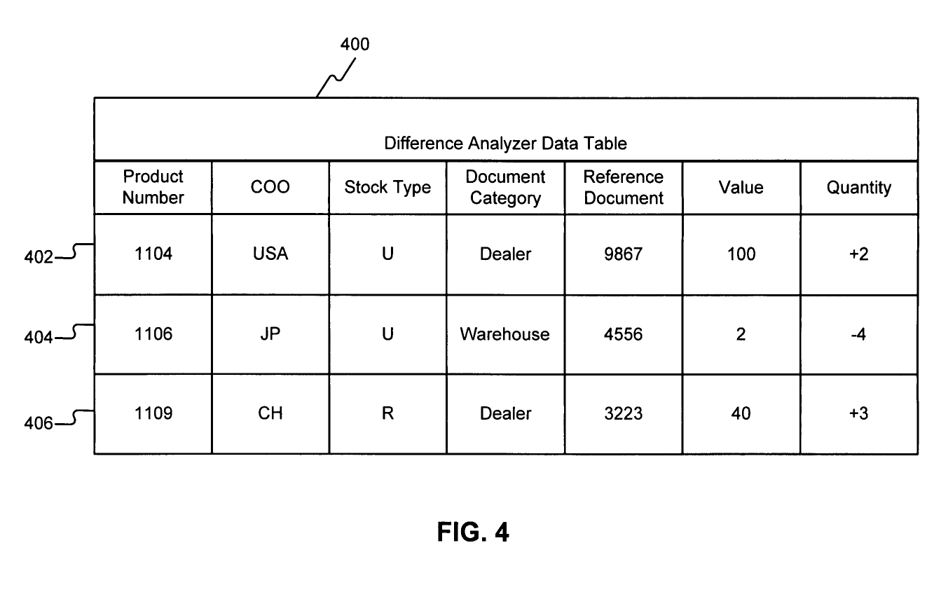

When a discrepancy is identified by, for example, inventory server 210, difference analyzer 216 may store a data record for one or more items of stock identified in the discrepancy data. As an example, a dealer may submit a claim to a distributor indicating that the dealer is missing a quantity of a particular item. A record including the indicated quantity of the item may be posted to difference analyzer 216 at the direction of inventory system 210 and/or via manual entry. If, for example, the dealer ordered ten of a particular part, but only received nine parts, a record including a credit of one part (i.e., a +1 quantity for that item) is stored in, for example, data storage 217 of difference analyzer 216. An exemplary data structure including exemplary records for storing discrepancies is described in more detail in connection with FIG. 4.

Terminals 220-240 may be any type of device for communicating with inventory server 210 and/or difference analyzer 216 over network 250. For example, terminals 220-240 may be personal computers, handheld devices, or any other appropriate computing platform or device capable of exchanging data with network 250, inventory server 210, and/or difference analyzer 216. Terminals 220-240 may each include a processor and a data storage. Further, terminals 220-240 may execute program modules that provide one or more graphical user interfaces (GUIs) for interacting with network resources to transmit and/or receive data from inventory server 210 and/or difference analyzer 216.

Users may access data provided by inventory server 210 via network 250 through a web browser or software application running on, for example, any one of terminals 220-240. For example, a web portal may include options for allowing a user to log onto a secure site provided by inventory server 210 by supplying credentials, such as a username and a password. Once logged onto the site, the web portal may display a series of screens prompting the user to make various selections for reviewing inventory and updating inventory in inventory server 210. Since some disclosed embodiments may be implemented using an HTTPS (hypertext transfer protocol secure) environment, data transfer over a network, such as the Internet, may be done in a secure fashion.

In some embodiments, a web interface generated by inventory server 210 that is displayed to users of terminals 220-240 may provide various options. For example, a user may use terminal 220 to retrieve data from inventory server 210 including a location of a particular type of stock in warehouse 105. Further, a user may generate a report at terminal 220, which indicates the location of stock in warehouse 105.

One or more of the components illustrated in FIG. 2 may be physically located at warehouse 105 or located remotely from the warehouse at, for example, a head office or management facility. Therefore, the location of inventory server 210 and other components are not critical for implementing the systems and methods disclosed herein.

FIG. 3 is an exemplary data table 300 of exemplary inventory records 302-306, consistent with a disclosed embodiment. In one embodiment, data table 300 may be stored in database 214 of inventory server 210. One of ordinary skill in the art will recognize that in other embodiments, data table 300 may be stored in other locations, such terminals 220-240, for example.

As shown in FIG. 3, each row of data table 300 represents a particular record. Furthermore, each of records 302-306 represents a particular bin and its associated stock. In particular, each of records 302-306 include a bin number, product number, country of origin (COO), stock type, and quantity of the stock in the bin. Bin numbers and product numbers may include numerical digits, letters, or a combination of alphanumeric characters. The “stock type” may indicate whether the stock is or is not currently available for sale. For example, the “stock type” may be unrestricted (i.e., the stock is currently available for sale) or restricted (i.e., the stock is not currently for sale). For example, data table 300 indicates that thirty parts having product number 1104 and that originated from the United States are stored in bin 1101 and eleven parts having the same product number that originated from China are stored in bin 1103. One of ordinary skill in the art will recognize that data table 300 is merely exemplary and may only describe a portion of stock stored in database 214.

FIG. 4 is an exemplary data table 400 of exemplary records 402-406 for storing stock discrepancies, consistent with a disclosed embodiment. In one embodiment, data table 400 may be stored in data storage 217 of difference analyzer 216. One of ordinary skill in the art will recognize that in other embodiments, data table 400 may be stored in inventory server 210 or terminals 220-240, for example.

As shown in FIG. 4, each row of data table 400 represents a particular record. Furthermore, each of records 402-406 represents a discrepancy that may be associated with a particular claim that has been stored and/or received by difference analyzer 216. Each of records 402-406 include a product number, country of origin (COO), stock type, document category, reference document, value, and a quantity of stock. As discussed above, product numbers may include numerical digits, letters, or a combination of alphanumeric characters and the “stock type” may be unrestricted (i.e., the stock is currently available for sale) or restricted (i.e., the stock is not currently for sale). The “document category” may indicate whether the discrepancy is due to a dealer claim, an inter-facility discrepancy, or a warehouse task discrepancy. The “reference document” may indicate a claim number or receipt number for purposes of tracking the claim.

As shown in FIG. 4, record 402 indicates the product number is 1104, the United States is the country of origin, the stock type is unrestricted, the document category indicates it is a dealer claim, the reference document is 9867, the value is $100.00 per quantity, and the quantity is +2. The quantity of +2 includes that the dealer was missing two of a particular item. Thus, it is expected that the warehouse includes two additional pieces of the item that are not otherwise accounted for in inventory server 210.

As another example, record 404 indicates a product number of 1106, Japan is the country of origin, the stock type is unrestricted, the document category indicates a warehouse claim, the reference document is 4556, the value is $2.00 per quantity, and the quantity is −4. The quantity of −4 indicates that the warehouse is missing four of the particular item that may not be otherwise accounted for in inventory server 210. As yet another example, record 406 indicates a product number of 1109, China is the country of origin, the stock type is restricted, the document category indicates it is a dealer claim, the reference document is 3223, the value is $40.00 per quantity, and the quantity is +3. The quantity of +3 indicates that the warehouse has three extra of the particular item.

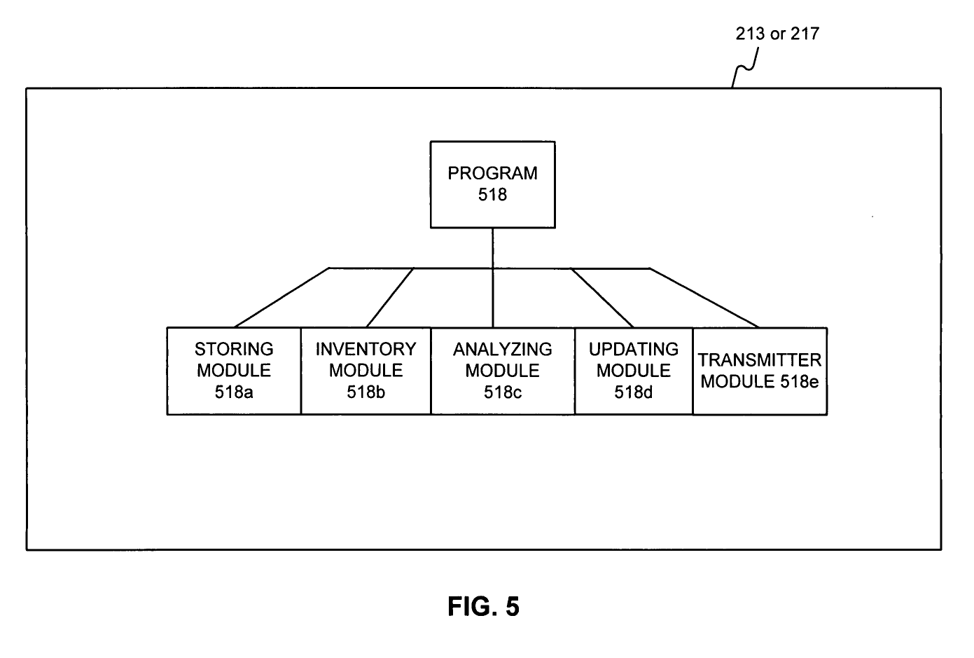

FIG. 5 is an exemplary software architecture for evaluating stock discrepancies and automatically determining whether to update bin quantities for a particular stock in inventory server 210, consistent with a disclosed embodiment. The software architecture may stored in data storage 213 of inventory server 210, as shown in FIG. 2, for example. In other embodiments, the software architecture may be stored in data storage 217 of difference analyzer 216.

In one embodiment, data storage 213 or 217 may store instructions of program 518, which when executed, perform a process to automatically determine whether to update bin quantities for a particular stock. To do so, program 518 may include instructions in the form of one or more software modules 518a-518e. Software modules 518a-518e may be written using any known programming language, such as C++, XML, etc., and may include a receiving and storing module 518a, a inventory module 518b, an analyzer module 518c, an updating module 518d, and a transmitter module 518e.

Receiving and storing module 518a may receive and store a discrepancy provided by inventory server 210. For example, inventory server 210 may receive a claim from one of terminals 220-240. The claim may be a dealer claim, a inter-facility claim, or a warehouse claim. For any incoming claim, the claim may be forwarded by inventory server 210 to difference analyzer 216 for further processing. The claim may include data stored in a data structure such as a record, as shown in FIG. 3. For example, the record may include a product number, country of origin (COO), stock type, document category, reference document, value, and a quantity of stock. Further, the record may be received by difference analyzer 216 and stored in data storage 217 at the direction of storing module 518a.

Inventory module 518b may verify inventory levels of the stock identified in a received discrepancy by interfacing with inventory server 210. For example, inventory module 518b may examine database 214 in order to identify all inventoried stock having the product number associated with a particular claim. For example, as shown in FIG. 3, although bins 1101 and 1103 have different countries of origins, the bins store stock having the same product number. Accordingly, inventory module 518b will aggregate all quantities of a particular stock to determine a total for a particular product number. Aggregation by inventory module 518b is performed regardless of country of origin, stock type, or document category. Accordingly, even though data table 300 indicates that thirty parts having product number 1104 and that originated from the United States are stored in bin 1101 and eleven parts having the same product number and that originated from China are stored in bin 1103, inventory module 518b will sum these quantities to arrive at a total of forty-one parts.

Analyzing module 518c may compare the discrepancy with the total sum of parts reflected in inventory server 210. In some circumstances, the comparison may resolve the discrepancy. In other circumstances, analyzing module 518c may determine whether the discrepancy falls within a predetermined tolerance. For example, a tolerance value may be calculated by analyzing module 518c for a particular stock. The tolerance value may based on a formula that takes into account a value of the stock, a percentage of average inventory for the stock over a specified period of time, or a combination of the value of the stock and the percentage of average inventory for the stock.

For example, if the sum of the value of the stock at issue is less than the tolerance value, then analyzing module 518c may determine that the bin quantities for the stock should be automatically updated to reflect more or less stock depending upon the particular circumstances. For example, a claim may indicate that two pieces of stock were not received by a dealer. Accordingly, it is expected that the two pieces of stock are in the warehouse. If the value of the two pieces of stock is less than a tolerance value, then analyzing module 418c may determined that bin quantities should be automatically updated for the stock. In another example, if the quantity of stock reported in the claim is less than a certain percentage of average inventory, then analyzing module 518c may determined that bin quantities should be automatically updated for the stock. Furthermore, in yet another example, if the value of the stock reported in the claim are less than a predetermined cost and less than a predetermined percentage of average inventory, then analyzing module 518c may determined that bin quantities should be automatically updated for the stock. However, if the discrepancy does not fall within the tolerance value, analyzing module 518c may determined that a bin quantity for the stock should not be updated with the quantity that is stored in difference analyzer 216.

Updating module 518d may cause inventory server 210 to update a quantity of the stock in database 214 and/or post the record for the discrepancy from difference analyzer 216 to a financial department database. For example, once it has been determined by analyzing module 518c that a quantity of a particular stock should be updated, updating module 518d may instruct inventory server 210 to adjust an inventory level of a stock to reflect more or less stock depending upon the particular circumstances. Further, the record of the discrepancy stored in difference analyzer 216 is posted to a financial department database. However, if analyzing module 518c determined that a bin quantity for the stock should not be updated with the quantity that is stored in difference analyzer 216, updating module 518d may only not post the record stored in difference analyzer 216 to a financial department database. Further, the updating may occur by updating a bin quantity in inventory server 210 for that product number. If more than one bin is assigned to the product number, the updated amount may be assigned to the bin that had the discrepancy. In other embodiments, the bin that previously had its quantity level increased or decreased may be selected for adjustment by updating module 518d.

Transmitter module 518e may transmit notifications to other departments. For example, transmitter module 518e may generate and format an appropriate message (such as an e-mail, voice mail, text message, etc.) and transmit that message to another system or one of terminals 220-240 for processing by a clerk. For example, if analyzing module 518c determined that a bin quantity for a stock should not be updated, a clerk may be required to review the situation and may need to perform a recount and/or investigate the original claim.

Although program modules 518a-518e have been described above as being separate modules, one of ordinary skill in the art will recognize that functionalities provided by one or more modules may be combined. Furthermore, one of ordinary skill in the art will recognize that program 518 may reside in inventory server 210, difference analyzer 216, or in any one of terminals 220-240.

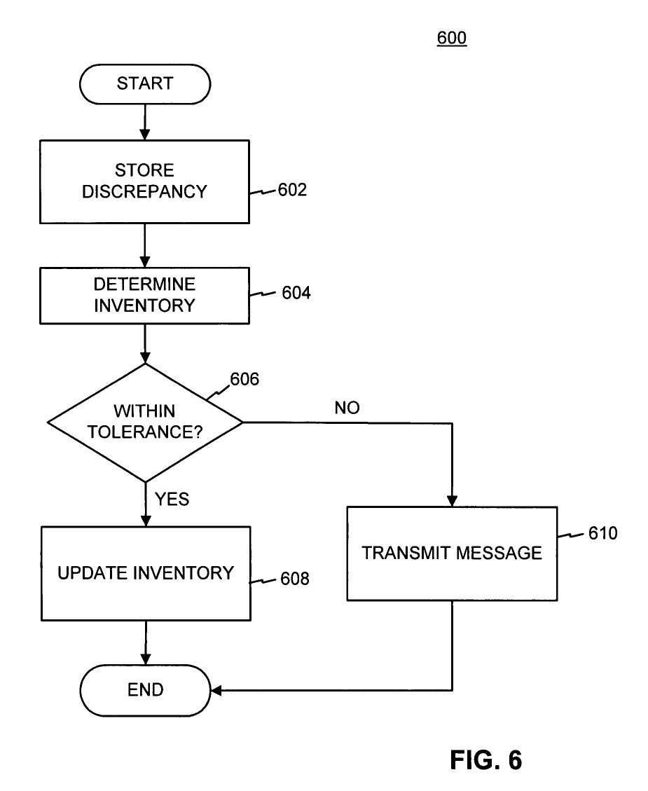

Referring now to FIG. 6, a flow diagram 600 is provided of an exemplary method for evaluating stock discrepancies and automatically determining whether to update bin quantities for a particular stock in inventory system 210, consistent with a disclosed embodiment. For example, the method may implement processes according to program modules 518a-518e.

At the start of the process, in step 602, receiving and storing module 518a of difference analyzer 216 may receive and store a discrepancy. The discrepancy may be identified due to a claim, such as a dealer claim, inter-facility claim, or a warehouse claim having been received by inventory server 210 and/or discrepancy server 216. For example, receiving and storing module 518a may store a discrepancy provided by inventory server 210 that was received from one of terminals 220-240. The process proceeds to step 604.

Next, in step 604, inventory server 210 verifies inventory levels of the identified stock. For example, inventory module 518b may verify inventory levels of the stock identified in a received discrepancy by interfacing with inventory server 210. Furthermore, inventory module 518b may examine data stored by inventory server 210 to identify all inventoried stock having the product number associated with a particular claim. Inventory module 518b will aggregate all quantities of a particular stock to determine a total. Accordingly, aggregation by inventory module 518b is performed regardless of country of origin, stock type, or document category. The process proceeds to step 606.

In step 606, analyzing module 518c determines whether the discrepancy falls within a predetermined tolerance value. If the discrepancy falls within the predetermined tolerance value, then the process proceeds to step 608. If the discrepancy does not fall within the predetermined tolerance value, difference analyzer 216 will not update the bin quantity for the stock with the quantity that is stored in difference analyzer 216 and the process proceeds to step 610.

In step 608, updating module 518d will update the bin quantity for the stock stored in inventory system 210 with the quantity that is stored in difference analyzer 216. Accordingly, the quantity of the stock having the particular product number will be increased or decreased by the quantity stored in difference analyzer 216. The updating may occur by updating a bin quantity in inventory server 210 for that product number and that had the discrepancy. The process then ends.

In step 610, if analyzing module 518c determined that a bin quantity for a stock should not be updated with the quantity that is stored in difference analyzer 216 and updating module 518d may post he record from difference analyzer 216 to a financial department database, then transmitter module 518e may generate and format an appropriate message (such as an e-mail, voice mail, text message, etc.) and transmit that message to another system or one of terminals 220-240 for processing by a clerk. For example, if analyzing module 518c determined that a bin quantity for a stock should not be updated, a clerk may be required to review the situation and may need to perform a recount and/or investigate the original claim. The process then ends.

As one of ordinary skill in the art will appreciate, one or more of the above steps may be optional and may be omitted from implementations in certain embodiments. In alternative embodiments, in step 610, instead of performing a recount or having a worker investigate the claim, the amount could be cleared from difference analyzer 216 or the amount could be posted it to a financial department, which would result in a write off.

### INDUSTRIAL APPLICABILITY

Systems or methods store a discrepancy representing an item of stock that may be on hand in a warehouse due to, for example, a customer submitting a claim indicating that a shipment was missing an item. Further, when a customer claim is made, the system or method stores the discrepancy as a separate record in a data storage, which acts a placeholder until the discrepancy is resolved. According to the system or method, after inventory is verified, a bin quantity in the warehouse inventory system is automatically updated with the discrepancy stored in the data storage. In particular, the system or method may update the bin quantity automatically based on whether or not the discrepancy falls within a tolerance level. For example, if the stock is of a small value and/or less than a certain percentage of average inventory, then the bin quantity is automatically updated. Further, when updating a bin quantity, the update takes into account an aggregate total of the stock item at issue, regardless of country of origin of the stock on hand.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments. For example, the described implementations include software, but systems and methods consistent with the present invention may be implemented as a combination of hardware and software or in hardware alone. Examples of hardware include computing or processing systems, including personal computers, servers, laptops, mainframes, microprocessors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A system for automatically resolving stock discrepancies, the system comprising:
a difference analyzer that stores a record of a claim specifying a discrepancy involving stock; and
an inventory server comprising a database of inventory records, wherein the inventory server determines an aggregate quantity of all stock having a product number corresponding to the claim and having any country of origin, stock type, or document category, and determines whether the discrepancy falls within a tolerance.

2. The system of claim 1, wherein the claim is one of a dealer claim, inter-facility claim, and warehouse claim.

3. The system of claim 1, wherein the discrepancy falls within the tolerance when a value of the stock specified in the claim is less than a predetermined cost.

4. The system of claim 1, wherein the discrepancy falls within the tolerance when a quantity of the stock specified in the claim is less than a predetermined percentage of average inventory of the stock.

5. The system of claim 1, wherein the discrepancy falls within the tolerance when a value of the stock specified in the claim is less than a predetermined cost and a quantity of the stock specified in the claim is less than a predetermined percentage of average inventory of the stock.

6. The system of claim 1, wherein the inventory server updates a bin quantity for the stock that is stored in the database with the quantity that is stored in difference analyzer if the discrepancy falls within the tolerance.

7. The system of claim 1, wherein the inventory server transmits a message if the discrepancy does not fall within the tolerance.

8. A method for automatically resolving stock discrepancies, the method comprising:
receiving a claim specifying a discrepancy involving stock;
storing a record of the claim in a difference analyzer;
determining an aggregate quantity of all stock that is stored in a database of an inventory server that has a product number corresponding to the claim and has any country of origin, stock type, or document category; and
determining whether the discrepancy falls within a tolerance.

9. The method of claim 8, wherein the claim is one of a dealer claim, inter-facility claim, and warehouse claim.

10. The method of claim 8, wherein the discrepancy falls within the tolerance when a value of the stock specified in the claim is less than a predetermined cost.

11. The method of claim 8, wherein the discrepancy falls within the tolerance when a quantity of the stock specified in the claim is less than a predetermined percentage of average inventory of the stock.

12. The method of claim 8, wherein the discrepancy falls within the tolerance when a value of the stock specified in the claim is less than a predetermined cost and a quantity of the stock specified in the claim is less than a predetermined percentage of average inventory of the stock.

13. The method of claim 8, wherein the inventory server updates a bin quantity for the stock that is stored in the database with the quantity that is stored in difference analyzer if the discrepancy falls within the tolerance.

14. The method of claim 8, wherein the inventory server transmits a message if the discrepancy does not fall within the tolerance.

15. A computer-readable medium storing instructions executable by a processor for automatically resolving stock discrepancies according to a method, the method comprising:
receiving a claim specifying a discrepancy involving stock;
storing a record of the claim in a difference analyzer;
determining an aggregate quantity of all stock that is stored in a database of an inventory server that has a product number corresponding to the claim and has any country of origin, stock type, or document category; and
determining whether the discrepancy falls within a tolerance.

16. The computer-readable medium of claim 15, wherein the discrepancy falls within the tolerance when a value of the stock specified in the claim is less than a predetermined cost.

17. The computer-readable medium of claim 15, wherein the discrepancy falls within the tolerance when a quantity of the stock specified in the claim is less than a predetermined percentage of average inventory of the stock.

18. The computer-readable medium of claim 15, wherein the discrepancy falls within the tolerance when a value of the stock specified in the claim is less than a predetermined cost and a quantity of the stock that is specified in the claim is less than a predetermined percentage of average inventory of the stock.

19. The computer-readable medium of claim 15, wherein the inventory server updates a bin quantity for the stock stored in the database with the quantity that is stored in difference analyzer if the discrepancy falls within the tolerance.

20. The computer-readable medium of claim 15, wherein the inventory server transmits a message if the discrepancy does not fall within the tolerance.
